(19) United States
(12) Patent Application Publication
(10) Pub. No.: US 2017/0190180 A1
(43) Pub. Date: Jul. 6, 2017

(54) LIQUID DISCHARGING APPARATUS

(71) Applicant: SEIKO EPSON CORPORATION, Tokyo (JP)

(72) Inventors: Yuto SUZUKI, Shiojiri (JP); Satoshi NEGISHI, Shiojiri (JP)

(21) Appl. No.: 15/394,357

(22) Filed: Dec. 29, 2016

(30) Foreign Application Priority Data
Jan. 5, 2016 (JP) 2016-000402

(51) Int. Cl. B41J 2/155

(52) U.S. Cl. CPC B41J 2/155

(57) ABSTRACT

A liquid discharging apparatus includes a support base that supports a medium which is transported; and a discharge head that is fixedly disposed at a position facing the support base with a gap between the discharge head and the support base and discharges liquid on the medium which passes over the support base.

### BACKGROUND

### 1. Technical Field

The present invention relates to a line head type liquid discharging apparatus which discharges liquid from a head which is fixedly disposed with respect to transported medium.

### 2. Related Art

In the related art, a head in which has nozzle arrays which are capable of discharging liquid (link) over the entire width direction intersecting with a transport direction of a medium which is transported to pass over a support base is fixedly disposed to face the support base in this type of line head type liquid discharging apparatus. A plurality of suction members that suck ink which is discharged from the head during flushing are provided in the support base of the liquid discharging apparatus having the head described above (For example, refer to JP-A-2004-9667).

With reference to FIG. 15 to FIG. 20, the configuration of the head and the support base of the liquid discharging apparatus in the related art will be described.

As illustrated in FIG. 15, nozzle arrays 111 in which a plurality of nozzles are arrayed in the direction intersecting with (obliquely intersecting with in FIG. 15) the transport direction YR of the medium is formed on a surface facing the support base in the head 110.

As illustrated in FIG. 16, a plurality of ribs 121 which support the medium PR (see FIG. 17) and a plurality of suction members 122 are alternately provided in the direction perpendicular to the transport direction YR in the support base 120. The plurality of ribs 121 and the plurality of suction members 122 extend in the direction along the nozzle arrays 111 (see FIG. 15). Accordingly, as illustrated in FIG. 17, in a case where ink is discharged from the nozzle arrays 111 onto the medium PR, a cock ring is formed so that the medium PR hangs down between adjacent ribs 121 in the direction perpendicular to the transport direction YR.

By the way, as illustrated in FIG. 16, since the rib 121 extends in the direction intersecting with the transport direction YR, as illustrated in FIG. 17 and FIG. 18, if a position in the transport direction YR of the medium PR on the rib 121 is changed, the position of the medium PR on the rib 121 is changed in the direction perpendicular to the transport direction YR. Accordingly, as illustrated in FIG. 18, if the medium PR on which ink is discharged by the nozzle arrays 111 is transported, there is a case the medium PR in an area on which the cock ring is formed runs over the rib 121. In this case, since the medium PR in an area on which the cock ring is not formed is transported in a state where the medium PR is lifted toward the head 110 from the rib 121, there is a risk of rubbing against the head 110. Even if a hole through which ink is passed is formed on the support base 120 instead of the suction member 122, as the rib 121 is formed, a similar problem is generated.

In addition, as illustrated in FIG. 19, in a case of a head 130 on which the nozzle arrays 131 in which the plurality of nozzles are arrayed in the direction intersecting with the transport direction YR are formed in a zigzag shape (hereinafter also referred to as “zigzag pattern”) in the transport direction YR and in the direction perpendicular to the transport direction YR, the ribs 141 are disposed in the zigzag pattern in the support base 140 in order to face a gap between the nozzle arrays 131 (see FIG. 19) so that the rib does not extend in the direction intersecting with the transport direction YR, as illustrated in FIG. 20. However, since the rib 141 has a short length in the transport direction YR and only one rib 141 is formed in the transport direction YR, the cock ring is unlikely to be formed between an adjacent ribs 141 in the direction perpendicular to the transport direction YR, even if ink is discharged from the nozzle array 131 onto the medium PR (see FIG. 17) transported onto the support base 140.

### SUMMARY

An advantage of some aspects of the invention is that a liquid discharging apparatus in which a cock ring is likely to be formed on a medium and which can suppress contact between the medium and the head with each other is provided.

Hereinafter, means of the invention and operation effects thereof will be described.

According to an aspect of the invention, there is provided a liquid discharging apparatus includes a support base that supports a medium which is transported; and a line type discharge head that is disposed at a position facing the support base with a gap between the discharge head and the support base and discharges liquid on the medium which passes over the support base. The discharge head includes a plurality of nozzle arrays which are arrayed in the direction which is obliquely intersected with a transport direction of the medium, and the support base includes an upstream rib and a downstream rib, and a plurality of receiving portions which are positioned at a location facing each of the plurality of nozzle arrays and which receive the liquid which is discharged from the plurality of nozzle arrays during flushing of the discharge head, the upstream rib and the downstream rib are positioned in an area between a nozzle in an upstream end and a nozzle in a downstream end in the transport direction, in one nozzle array in the plurality of nozzle arrays, the upstream rib is positioned at least in the upstream of the nozzle of the downstream end and the downstream rib is positioned at least in the downstream of the nozzle of the upstream end, and, with respect to a virtual line connecting a center of each nozzle of one nozzle array, the upstream rib is positioned in the upstream of the transport direction than the virtual line and the downstream rib is positioned in the downstream of the transport direction than the virtual line.

According to the configuration, a cock ring is likely to be formed on the medium on which liquid is discharged, since the medium on which liquid is discharged is supported along the transport direction by the plurality of ribs (upstream rib and downstream rib). In addition, the position in which the rib supports the medium is not changed in the direction perpendicular to the transport direction even if the medium on which the liquid is discharged is transported so as to pass over the ribs. Accordingly, in a case where the cock ring is formed on an area which corresponds to the gap between adjacent ribs in the medium, the contact between the medium and the head with each other can be suppressed, since the area on which the cock ring is formed on the medium does not ride over the rib even if the medium is transported.

In addition, in the liquid discharging apparatus, it is preferable that each position which is sandwiched between the upstream rib and the downstream rib in adjacent abandonment portions to each other be different from each other in the direction intersecting with the transport direction among the plurality of abandonment portions.

According to the configuration, the position on which the abandonment portion is disposed and which is between the plurality of ribs can be made different in the transport direction. Therefore, a distal end portion of the medium in the transport direction being caught by the rib of the downstream side of the plurality ribs in the transport direction can be suppressed. In other words, with respect to an upstream end of a plurality of downstream ribs arrayed in the direction intersecting with the transport direction, since the transported media are passed at different timings from each other, the catch of the distal end portion of the medium can be suppressed, unlike in a case of the upstream ends of the downstream ribs being all the same.

In addition, in the liquid discharging apparatus, it is preferable that the support base include an upstream rib which corresponds to another nozzle array and a downstream rib which corresponds to another nozzle array, which is adjacent to one nozzle array in the transport direction, and that the upstream rib which corresponds to another nozzle array be common to the downstream rib which corresponds to the one nozzle array.

According to the configuration, a cock ring is likely to be formed on the medium on which liquid is discharged, since the medium on which liquid is discharged is supported along the transport direction by the plurality of ribs (upstream rib and downstream rib) being arrayed along the transport direction. In addition, the position in which the rib supports the medium is not changed in the direction perpendicular to the transport direction even if the medium on which the liquid is discharged is transported so as to pass over the ribs. Accordingly, in a case where the cock ring is formed on an area which corresponds to the gap between adjacent ribs in the medium, contact between the medium and the head with each other can be suppressed, since the area on which the cock ring is formed in the medium does not ride over the rib even if the medium is transported. Further, manufacturing cost can be reduced by the downstream rib which corresponds to the one nozzle array and the upstream rib which corresponds to another nozzle array being common to each other. It is preferable that the upstream rib and the downstream rib (being common to the upstream rib corresponding to another nozzle array) which correspond to one nozzle array and the upstream rib (being common to the downstream rib corresponding to one nozzle array) and downstream rib which correspond to another nozzle array be disposed side by side along the transport direction. However, each rib may be offset and disposed in the direction perpendicular to the transport direction. In this case, it is preferable that each virtual line which passes through the center in the width direction of each rib and follows the transport direction be limited to be offset and disposed to the extent which passes over each rib.

In addition, in the liquid discharging apparatus, it is preferable that a plurality of upstream ribs and a plurality of downstream ribs be formed in the direction perpendicular to the transport direction, and that an end edge of each medium in the width direction having a width dimension which is capable of transporting be disposed in order not to be in contact with each of the plurality of upstream ribs and the plurality of downstream ribs, among a plurality of media having a plurality of width dimensions defined by the standard in advance. For example, it is preferable that the end edge project by about 1 mm to outsides (a side in which medium does not exist, in the width direction of the medium) of the upstream rib and the downstream rib in the direction of the medium.

According to the configuration, falling of the distal end portion of the medium in the transport direction in the position between the plurality of ribs in which the abandonment portion is disposed is suppressed in a case where the medium is transported over the plurality of ribs (upstream rib and downstream rib) in the transport direction. Therefore, catch of the distal end portion of the medium in the transport direction by the rib of the downstream side in the transport direction of the plurality ribs can be suppressed.

In addition, in the liquid discharging apparatus, it is preferable that a suction mechanism that sucks the liquid which is discharged during flushing of the discharge head in an inside portion of the support base through the abandonment portion further be included.

According to the configuration, since the suction mechanism sucks the liquid which is discharged from the discharge head toward the abandonment portion, the width of the abandonment portion is not required to be made excessively large in the direction perpendicular to the transport direction. Therefore, a distance between the upstream side rib in the transport direction and the downstream side rib in the transport direction of the ribs which is divided by the abandonment portion can be decreased. Therefore, since falling of the distal end portion of the medium in the transport direction from the upstream side rib in the transport direction to the abandonment portion is further suppressed, a posture of the medium which is supported by the rib can be stabilized.

### BRIEF DESCRIPTION OF THE DRAWINGS

The invention will be described with reference to the accompanying drawings, wherein like numbers reference like elements.

FIG. 1 is a schematic front view according to a liquid discharging apparatus of a first embodiment.

FIG. 2 is a schematic plan view of a discharge head.

FIG. 3 is a schematic plan view of a support base.

FIG. 4 is a schematic cross-sectional view of the discharge head and the support base.

FIG. 5 is a schematic plan view of the support base for describing an operation.

FIG. 6 is a schematic plan view of the support base for describing an operation.

FIG. 7 is a schematic plan view of a support base according to a liquid discharging apparatus of a second embodiment.

FIG. 8 is a schematic plan view of a support base according to a liquid discharging apparatus of a third embodiment.

FIG. 9 is a schematic plan view of a discharge head according to a liquid discharging apparatus of a fourth embodiment.

FIG. 10 is a schematic plan view of the support base facing the discharge head of FIG. 9.

FIG. 11 is a schematic plan view of a discharge head according to a liquid discharging apparatus of a fifth embodiment.

FIG. 12 is a schematic plan view of the support base facing the discharge head of FIG. 11.

FIG. 13 is a schematic plan view of a support base in a liquid discharging apparatus of a modification example.

FIG. 14 is a schematic plan view of a support base in a liquid discharging apparatus of another modification example.

FIG. 15 is a schematic plan view of a discharge head according to a liquid discharging apparatus of the related art.

FIG. 16 is a schematic plan view of the support base facing the discharge head of FIG. 15.

FIG. 17 is a schematic cross-sectional view of the support base and the discharge head cut along with line XVII-XVII in FIG. 16 before the printed medium is transported.

FIG. 18 is a schematic cross-sectional view of the support base and the discharge head cut along with line XVIII-XVIII in FIG. 16 in a case where the printed medium is transported.

FIG. 19 is a schematic plan view of a discharge head according to another liquid discharging apparatus of the related art.

FIG. 20 is a schematic plan view of the support base facing the discharge head of FIG. 19.

### DESCRIPTION OF EXEMPLARY EMBODIMENTS

Hereinafter, a first embodiment to a fifth embodiment in which a liquid discharging apparatus is embodied in a printing apparatus will be described, with reference to drawings. In each embodiment, the printing apparatus is an ink jet printer which forms characters and images on paper by discharging ink as an example of liquid on paper as an example of a medium.

### First Embodiment

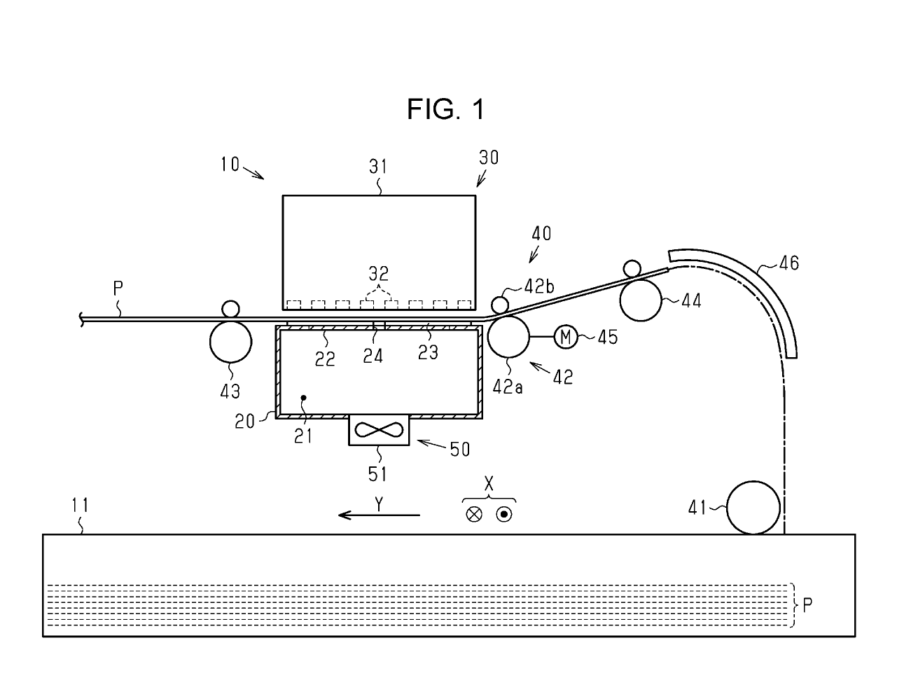

As illustrated in FIG. 1, the printing apparatus 10 includes a paper cassette 11 which is capable of accommodating stacked paper P, a support base 20 which supports paper P which is transported from the paper cassette 11, a printing portion 30 which performs printing on paper P supported by the support base 20, and a transport portion 40 which transports paper P on the support base 20. In the following description, the width direction of paper P is defined as “width direction X” and the transport direction of paper P is defined as “transport direction Y”. The width direction X is an example of the direction intersecting with the transport direction Y and is perpendicular to the transport direction Y.

The printing portion 30 includes a discharge head 31 which discharges ink on paper P which passes through a support base 20. The discharge head 31 is fixedly disposed on a position which faces the support base 20 with a gap between the discharge head 31 and the support base 20 and is a so called line head which is capable of discharging ink simultaneously over the width direction X. A plurality of nozzles 32 which are capable of discharging ink are opened in the discharge head 31. The discharge head 31 according to the present embodiment discharges only black color ink, for example. The discharge head 31 performs so called flushing which forcibly discharges ink from the nozzle 32 in a case where the viscosity of the ink in the nozzle 32 is increased due by being dried, or in a case where the ink is solidified. The flushing of the discharge head 31 is performed before start printing on paper P, for example.

The support base 20 is made of metal (for example, made of aluminum). In the support base 20, a suction mechanism 50 for sucking ink which is discharged from the nozzle 32 during the flushing of the discharge head 31 in an internal space 21 of the support base 20 is provided. The suction mechanism 50 includes a blower 51. The blower 51 drives during the flushing, for example. The blower 51 may be driven at the time of printing on paper P in addition to during the flushing.

The transport portion 40 includes a pickup roller 41 for feeding out the uppermost paper P in the paper cassette 11, a pair of transport rollers 42 which transport paper P fed by the pickup roller 41 toward the support base 20, and a pair of paper discharge rollers 43 which discharges the paper P which are passed over the support base 20. In addition, the transport portion 40 includes a pair of relay rollers 44 which are provided in the middle of a transport path (one-dot chain line) between the pickup roller 41 and the pair of transport rollers 42 and transports paper P to the pair of transport rollers 42. The pair of transport rollers 42 includes a driving roller 42a which is rotated by a motor 45 using the width direction X as an axial direction and a driven roller 42b which is driven to be rotated using the width direction X as an axial direction. As illustrated in FIG. 1, the driven roller 42b is disposed on the upper side than the driving roller 42a and on the downstream side of the transport direction Y. Accordingly, the paper P is transported so as to be pressed against the support base 20.

According to the configuration, paper P of the paper cassette 11 is fed out by the pickup roller 41, is transported toward a pair of relay rollers 44 by a guide portion 46 which is provided in the middle of a transport path, and is transported on the support base 20 by the pair of transport rollers 42. Printing is performed by ink being discharged from the discharge head 31 on the paper P on the support base 20. The paper P on which printing is performed is transported from the support base 20 to the downstream side of the transport direction Y by the pair of paper discharge rollers 43.

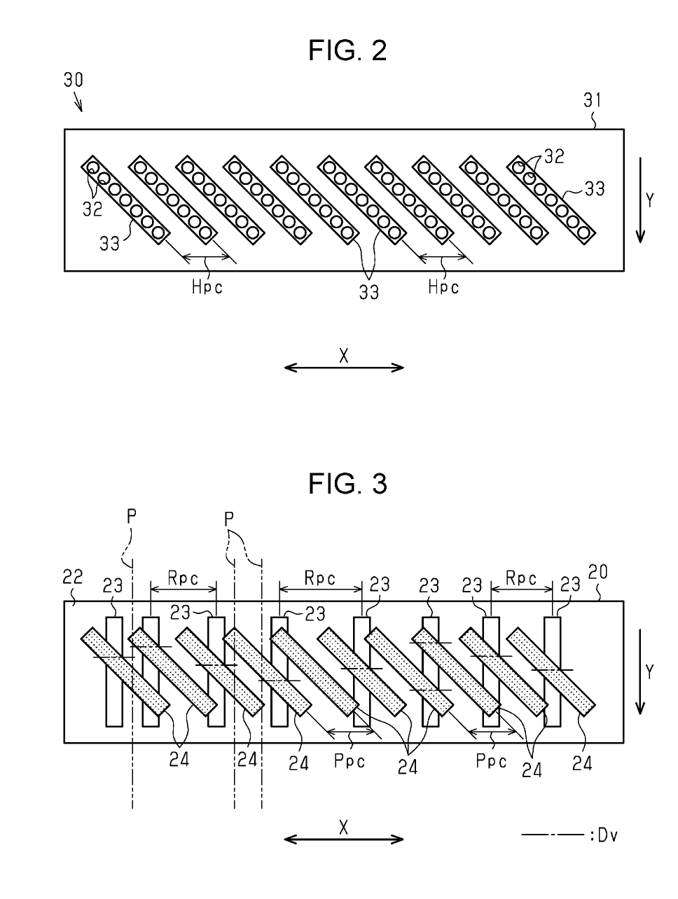

With reference to FIG. 2 to FIG. 4, a detailed construction of the support base 20 and the discharge head 31 will be described.

As illustrated in FIG. 2, a plurality of nozzle arrays 33 including a plurality of nozzles 32 are formed in a surface facing the support base 20 (see FIG. 1) in the discharge head 31. Each nozzle array 33 extends in the direction intersecting with the transport direction Y (obliquely intersecting in FIG. 2). Each nozzle array 33 according to the present embodiment extends in one side (right side of paper surface) of the width direction X toward the downstream of the transport direction Y. The plurality of nozzle arrays 33 are arrayed in the width direction X in a state of being parallel to each other. Some of the nozzle arrays 33 adjacent to each other in the width direction X overlap with each other in the transport direction Y. In addition, each distance Hpc connecting the nozzle arrays 33 adjacent to each other in the width direction X are equal to each other. Here, the distance Hpc is defined as a distance connecting in the width direction X a center of a nozzle 32 of the nozzle array 33 and a center of a nozzle 32 of nozzle array 33 which is adjacent to the nozzle 32 in the width direction X.

As illustrated in FIG. 3, a plurality of ribs 23 for supporting paper P and a plurality of abandonment portions 24 in which ink which is discharged from a plurality of nozzle arrays 33 (see FIG. 2) are capable of passing through an internal space 21 (see FIG. 1) during flushing of the discharge head 31 (see FIG. 2) are provided in a support portion 22 which supports paper P (see FIG. 1) in the support base 20. The plurality of abandonment portions 24 are illustrated by shading for clarifying the distinction from the plurality of ribs 23.

The plurality of ribs 23 are integrally formed with the support portion 22. Each of the plurality of ribs 23 is subjected to water repellent treatment, treatment for suppressing generation of static electricity, and abrasion resistance treatment. An example of a water repellent treatment is a fluorine coating. An example of the treatment for suppressing the generation of static electricity and the abrasion resistance treatment is a chromium plating treatment. Through these treatments, the ink discharged from the discharge head 31 during flushing is unlikely to adhere to the plurality of ribs 23. Then, the ink adhering to the portion of the plurality of ribs 23 adjacent to the abandonment portion 24 flows to the abandonment portion 24. In particular, the ink attached to the plurality of ribs 23 is sucked toward the abandonment portion 24 by the blower 51 of the suction mechanism 50 being driven during flushing. In addition, since generation of static electricity of the plurality of ribs 23 is suppressed, charging of the ink is suppressed. In addition, since abrasion of the plurality of ribs 23 due to transport of the paper P is reduced, increase in the distance between paper P supported by the ribs 23 and the discharge head 31 is suppressed. The plurality of ribs 23 may be formed separately from the support portion 22 and then attached to the support portion 22 or at least one of the above described three processing may be omitted. In addition, the three processing described above may be performed at least on the portion which is in contact with paper P in the rib 23.

The plurality of ribs 23 are arranged along the transport direction Y. The ribs 23 are formed at positions facing the gaps of the plurality of nozzle arrays 33 (see FIG. 2). In other words, the rib 23 does not face the plurality of nozzle arrays 33. The plurality of ribs 23 arrayed in the width direction X are disposed on a position which is different from end edges (a plurality of two-dot chain lines in FIG. 3) of a plurality of types of paper P in the width direction X in which positions of the plurality of ribs are different in a width dimension of paper P. In the present embodiment, the distances Rpc connecting adjacent ribs 23 in the width direction X are different from each other. The distances Rpc connecting the ribs 23 of some of the plurality of ribs 23 in the width direction X may be equal to each other. Accordingly, since the plurality of ribs 23 do not support the end edge, which is likely to be curl, of paper P in the width direction X, floating of the paper P from the rib 23 is suppressed. Therefore, contacting between the paper P and the discharge head 31 (see FIG. 2) with each other can be suppressed. Here, the distance Rpc is defined as the distance connecting in the width direction X between the center of the width of the rib 23 and the center of the width of the rib 23 adjacent to the rib 23 in the width direction X.

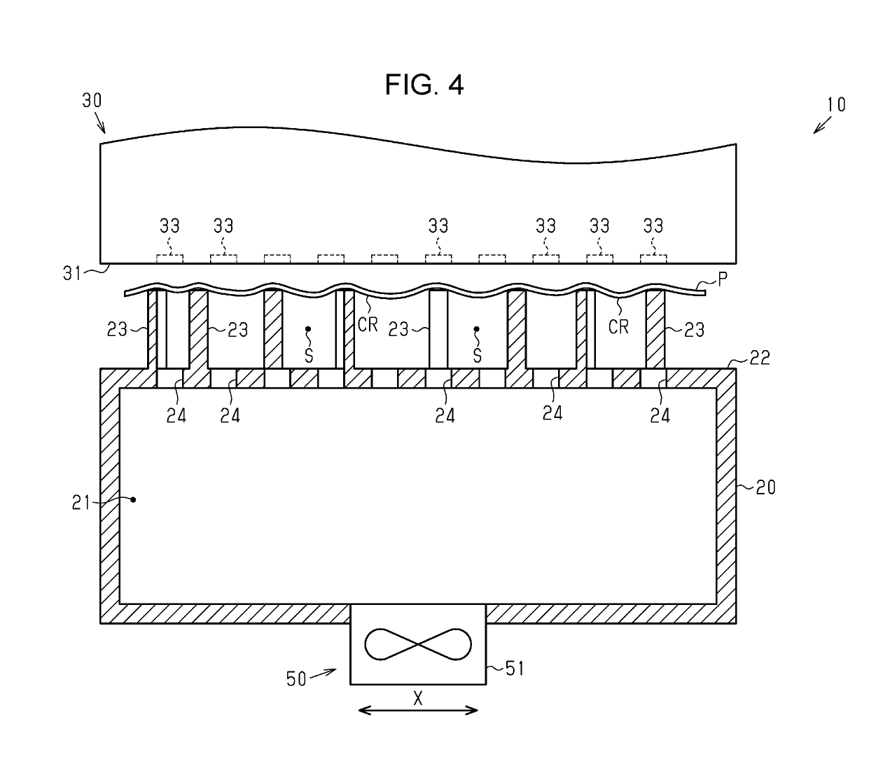

As illustrated in FIG. 4, the plurality of abandonment portions 24 are formed at positions facing the each nozzle arrays 33 in the support portion 22, and pass through the support portion 22 so as to communicate with the internal space 21. Therefore, the suction mechanism 50 sucks the ink discharged during the flushing of the discharge head 31 into the internal space 21 of the support base 20 through each of the abandonment portions 24. As illustrated in FIG. 3, the abandonment portion 24 is an elongated hole that extends to one side (right side of the page) in the width direction X as it goes downstream in the transport direction Y like the nozzle array 33 (see FIG. 2). Therefore, the distances Ppc connecting the adjacent abandonment portions 24 to each other in the width direction X are equal to each other. The distance Ppc is substantially equal to the distance Hpc (see FIG. 2) related to the nozzle array 33. The abandonment portion 24 extends between the plurality of ribs 23 arranged in the transport direction Y. The position of each of the rib-to-rib positions Dv in the transport direction Y, which is the position between the plurality of ribs 23 on which the abandonment portion 24 is disposed, is different from each other as illustrated by the one-dot chain line in FIG. 3. Here, the distance Ppc is defined as a distance connecting in the width direction X the center of the width of the abandonment portion 24 and the center of the width of an abandonment portion 24 adjacent to the abandonment portion 24 in the width direction X.

The operation of this embodiment will be described with reference to FIG. 3 to FIG. 6.

As illustrated in FIG. 3, since the plurality of ribs 23 are arranged along the transport direction Y, the paper P is supported along the transport direction Y, and as illustrated in FIG. 4, a space S which extends along the transport direction Y is formed between the ribs 23 adjacent to each other in the width direction X. Therefore, in a case where ink is discharged from the discharge head 31 on the paper P which is supported by each of the ribs 23, a so called cock ring which undulates so that the paper P hangs down in the space S is formed on the paper P on which ink is discharged from the discharge head 31. In the following description, the area where the cock ling is formed so that the paper P hangs down in the space S on the paper P is defined as “drooping area CR”.

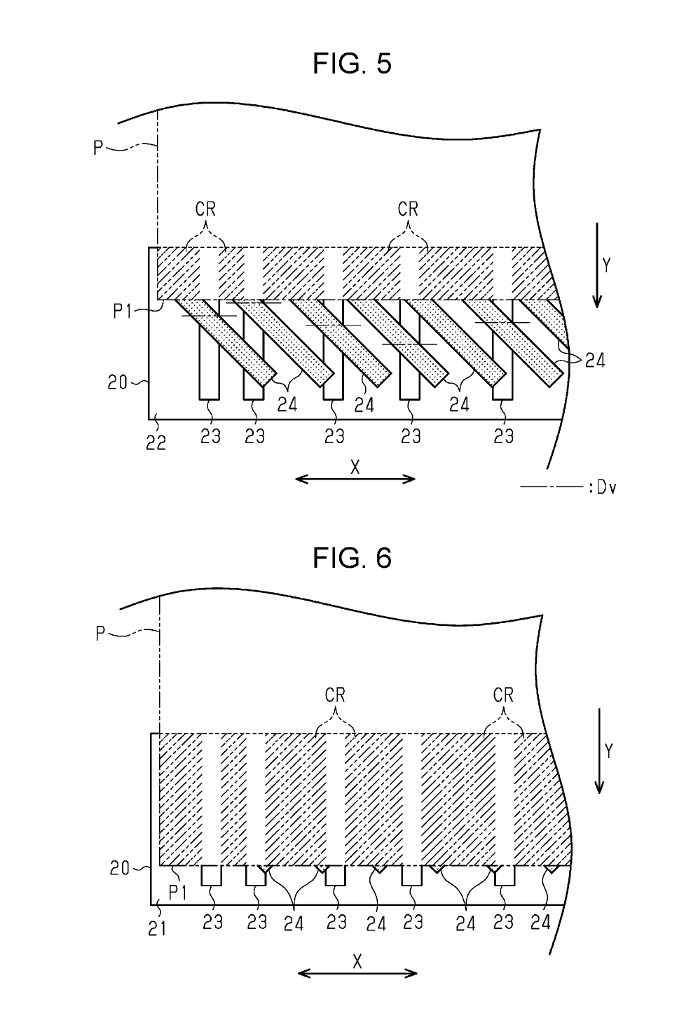

As illustrated in FIG. 5 and FIG. 6, since the plurality of ribs 23 are arranged along the transport direction Y, even if the printed paper P passes over the plurality of ribs 23, the position in the width direction X where the paper P is supported is not changed by the plurality of ribs 23. Therefore, even if the printed paper P passes over the plurality of ribs 23, the drooping area CR illustrated by shading on the paper P only moves between the plurality of ribs 23 in the width direction X and thus riding of the drooping area CR over the rib 23 is suppressed.

As illustrated by the one-dot chain line in FIG. 5, the plurality of ribs 23 have different rib-to-rib positions Dv in the transport direction Y. Therefore, even if a portion of the paper P in the width direction X at the distal end portion P1 in the transport direction Y is transported to the inter-rib position Dv of the predetermined rib 23 (the second from the left in FIG. 5), a portion of the distal end portion P1 which is different from a portion of the distal end portion P1 positioned in the rib-to-rib position Dv in the width direction X is supported by another rib 23. Therefore, falling of the distal end portion P1 of the paper P in the transport direction Y into the inter-rib position Dv over the entire width direction X is suppressed.

In a case where attention is paid to one rib 23 in the plurality of ribs 23 in FIG. 3, the ribs 23 are disposed so as to be divided in the transport direction Y by one abandonment portion 24 of the plurality of abandonment portions 24. In a case where the rib on the upstream side in the transport direction Y is used as the upstream rib and the rib on the downstream side in the transport direction Y is used as the downstream rib among the divided ribs 23, it is preferable that the upstream rib and the downstream rib be arranged linearly in the transport direction Y. Although a plurality of ribs 23 are disposed along the transport direction Y in disposition of the invention, it should be described how the one rib 23 should be disposed with respect to the one abandonment portion 24. Therefore, since one corresponding nozzle array 33 exists among the plurality of nozzle arrays 33 with respect to one abandonment portion 24, by using the one nozzle array 33, how the one rib 23 with respect to the one abandonment portion 24 is arranged will be described.

First, as illustrated in FIG. 2, a plurality of nozzles 32 exists in the one nozzle array 33. Here, with respect to the transport direction Y, the most upstream nozzle 32 in the one nozzle array 33 is used as the upstream end nozzle and the most downstream nozzle 32 is used as the downstream end nozzle. Then, a virtual line connecting the center of the nozzle at the upstream end and the center of the nozzle at the downstream end is assumed. At this time, the upstream rib and the downstream rib are disposed so that the upstream rib is positioned upstream of the virtual line in the transport direction Y and the downstream rib is positioned downstream from the virtual line in the transport direction Y (condition 1).

Further, the upstream rib is disposed upstream of the nozzle at the downstream end in the transport direction Y, and the downstream rib is disposed downstream of the nozzle at the upstream end in the transport direction Y (condition 2).

In other words, it is preferable that the upstream rib and the downstream rib which constitute one rib 23 are disposed so as to satisfy both (condition 1) and (condition 2) which are the conditions described above.

Further, in the manufacturing process of the liquid discharging apparatus, since some errors may occur in the disposition of the one rib 23, some disposition error should be taken into consideration. For example, the upstream rib and the downstream rib may be disposed so as to deviate to some extent in the direction intersecting with the transport direction Y. More specifically, the amount (distance) of the allowable range of the deviation with respect to the direction perpendicular to the transport direction Y can be defined as follows. In other words, it is assumed that a second virtual line, which is a virtual line along the transport direction Y, passes through the center of the upstream rib in the direction perpendicular to the transport direction Y. Similarly, it is assumed that a third virtual line, which is a virtual line along the transport direction Y, passes through the center of the downstream rib in the direction perpendicular to the transport direction Y. In a case where viewed from the viewpoint of FIG. 3, if each of the second virtual line and the third virtual line is manufactured so that the deviation of the disposition of the upstream rib and the downstream rib is controlled so as to pass through both the upstream rib and the downstream rib with respect to the direction perpendicular to the transport direction Y, the effect of the invention is not lost.

According to the present embodiment, the following effects can be obtained.

(1) Since the plurality of ribs 23 are arranged along the transport direction Y, rising of the area other than the drooping area CR on the paper P from the rib 23 is suppressed by the drooping area CR being likely to be formed on the printed paper P and the drooping area CR riding over the rib 23. Therefore, in a case where the printed paper P passes over the plurality of ribs 23, contact between the area other than the drooping area CR on the paper P and the nozzle array 33 of the discharge head 31 with each other can be suppressed. In addition, since the abandonment portion 24 is formed between the plurality of ribs 23 arranged in the transport direction Y, dependence of the size of the rib 23 in the width direction X on the width dimension of the abandonment portion 24 is suppressed. Therefore, the size of the rib 23 in the width direction X can be freely set.

(2) Since the rib-to-rib positions Dv of the plurality of ribs 23 disposed in the width direction X are different in the transport direction Y, the distal end portion P1 of the paper P is transported in a state of falling into the inter-rib position Dv across the entire width direction X and thus contact in the transport direction Y between the distal end portion P1 of the paper P and the rib 23 on the downstream side in the transport direction Y other than the abandonment portion 24 with each other is suppressed in the plurality of ribs 23 arranged in the transport direction Y.

Accordingly, since curling of the distal end portion P1 of the paper P is suppressed, the posture of the paper P on the plurality of ribs 23 is stabilized and deterioration in print quality can be suppressed.

(3) The ink discharged from the discharge head 31 is sucked toward the abandonment portion 24 and thus is sucked through the abandonment portion 24 into the internal space 21 of the support base 20 by the suction mechanism 50 being driven during the flushing of the discharge head 31. Therefore, even if the dimension of the abandonment portion 24 in the width direction X is not taken large, the ink discharged from the discharge head 31 can be sucked into the abandonment portion 24. Thereby, the distance between the ribs 23 adjacent to the abandonment portion 24 on the upstream side in the transport direction Y and the ribs 23 adjacent to the abandonment portion 24 on the downstream side in the transport direction Y can be reduced in the ribs 23 arranged in the transport direction Y. Therefore, since falling of the distal end portion P1 of the paper P into the abandonment portion 24 from the rib 23 on the upstream side in the transport direction Y other than the abandonment portion 24 over the entire width direction X can be further suppressed, the posture of the paper P which is supported by the rib 23 can be stabilized.

(4) Since the distance Rpc connecting the ribs 23 adjacent to each other in the width direction X is different from each other, the rib 23 is likely to be formed at a position different from the end edge of the paper P in the width direction X. Therefore, even if the type of paper P having different dimension in the width direction X increases, the ribs 23 can be formed at positions different from the end edges of paper P in the width direction X.

### Second Embodiment

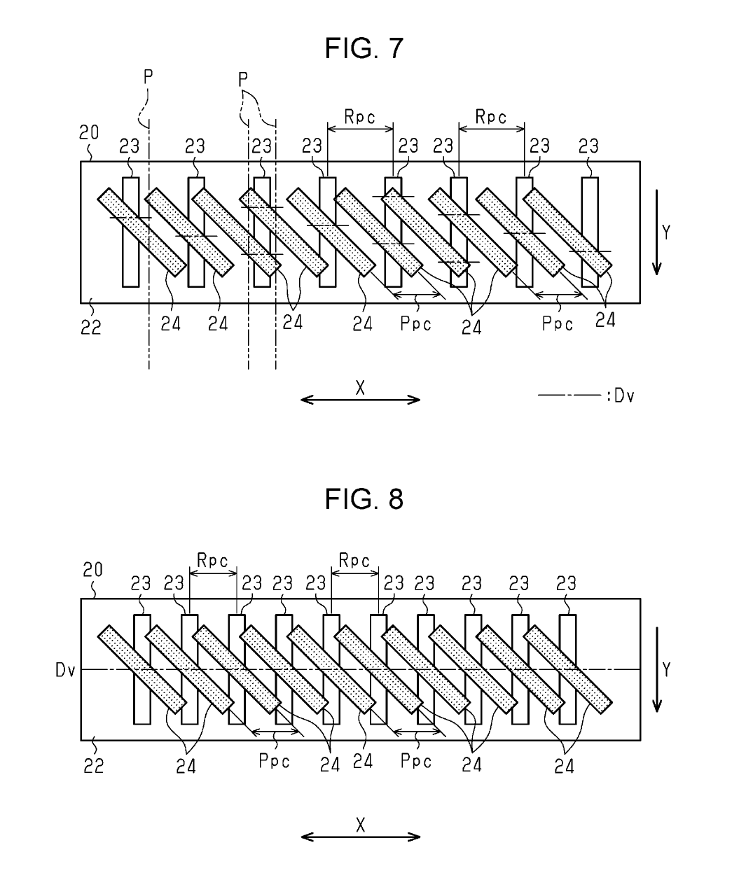

With reference to FIG. 7, a printing apparatus 10 of the second embodiment will be described. The printing apparatus 10 of the present embodiment is different from the printing apparatus 10 of the first embodiment in the position of the rib 23 of the support base 20 in the width direction X.

As illustrated in FIG. 7, each of the plurality of ribs 23 is arranged in the transport direction Y. The ribs 23 are formed at positions facing the gaps of the plurality of nozzle arrays 33 (see FIG. 2). In other words, the rib 23 does not face the plurality of nozzle arrays 33. The plurality of ribs 23 arrayed in the width direction X are disposed so that the positions thereof become positions which are different from the end edges (a plurality of two-dot chain lines in FIG. 7) of a plurality of types of paper P in the width direction X which are different in the width dimension of the paper P. The distance Rpc connecting the adjacent ribs 23 to each other in the width direction X which is the array direction of the plurality of ribs 23 is different from the distance Ppc connecting the adjacent abandonment portions 24 to each other in the width direction X which is an example of the arrangement direction of the plurality of abandonment portions 24. In the present embodiment, distances Rpc are equal to each other. This distance Rpc is larger than the distance Hpc (see FIG. 2) connecting the nozzle arrays 33 adjacent to each other in the width direction X. Therefore, the distance Rpc is larger than the distance Ppc. The array direction of the plurality of abandonment portions 24 and the array direction of the plurality of nozzle arrays 33 are not limited to the width direction X but may be directions intersecting with both in the width direction X and in the transport direction Y.

The abandonment portion 24 extends between the plurality of ribs 23 arranged in the transport direction Y.

As illustrated in FIG. 7, since the distance Rpc and the distance Ppc are different from each other, the position of each rib-to-rib position Dv (one-dot chain line in FIG. 7) in the transport direction Y is different from each other. According to the configuration, the same effects as those of (1) to (3) of the first embodiment can be obtained.

### Third Embodiment

With reference to FIG. 8, a printing apparatus 10 of a third embodiment will be described. The printing apparatus 10 of the present embodiment is different from the printing apparatus 10 of the first embodiment in the position of the rib 23 of the support base 20 in the width direction X.

As illustrated in FIG. 8, each of the plurality of ribs 23 is arranged in the transport direction Y. The ribs 23 are formed at positions facing the gaps of the plurality of nozzle arrays 33 (see FIG. 2). In other words, the rib 23 does not face the plurality of nozzle arrays 33. The distances Rpc connecting adjacent ribs 23 to each other in the width direction X are equal to each other. This distance Rpc is equal to the distance Hpc (see FIG. 2) connecting the nozzle arrays 33 adjacent to each other in the width direction X. Therefore, the distance Rpc is equal to the distance Ppc connecting the adjacent abandonment portions 24 to each other in the width direction X which is an example of the arrangement direction of the plurality of abandonment portions 24.

The abandonment portion 24 extends between the plurality of ribs 23 arranged in the transport direction Y.

As illustrated in FIG. 8, since the distance Rpc and the distance Ppc are equal to each other, the positions of the rib-to-rib positions Dv in the transport direction Y are equal to each other. Therefore, two ribs 23 are arranged in the transport direction Y with the abandonment portion 24 interposed therebetween. According to the configuration, the same effects as those of (1) and (3) of the first embodiment can be obtained.

### Fourth Embodiment

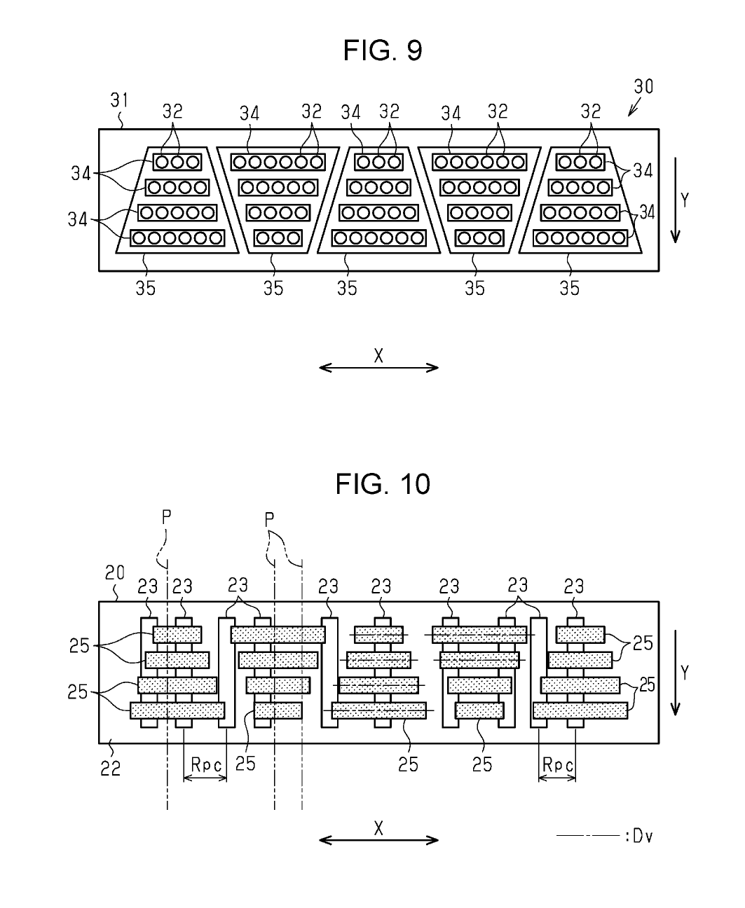

With reference to FIG. 9 and FIG. 10, a printing apparatus 10 of a fourth embodiment will be described. The printing apparatus 10 of the present embodiment is different from the printing apparatus 10 of the first embodiment in the nozzles 32 of the discharge head 31 being arranged differently, the positions of the ribs 23 of the support base 20 in the width direction X being different, and an abandonment portion 25 having a different shape and arrangement from the abandonment portion 24 being formed.

As illustrated in FIG. 9, a plurality of nozzle groups 35 in which the nozzle arrays 34 formed by arraying the nozzles 32 in the width direction X are arranged in the transport direction Y are formed in the discharge head 31. The plurality of nozzle groups 35 are arranged in the width direction X. The plurality of nozzle arrays 34 of the nozzle group 35 are formed such that the length in the width direction X of the nozzle array 34 is sequentially increased or shortened toward the downstream direction in the transport direction Y.

As illustrated in FIG. 10, each of the plurality of ribs 23 is arranged in the transport direction Y. The ribs 23 are formed at positions facing the gaps of the plurality of nozzle arrays 34 (see FIG. 9). In other words, the rib 23 does not face the plurality of nozzle arrays 34. The plurality of ribs 23 arrayed in the width direction X are disposed so that the positions thereof become positions which are different from the end edges (a plurality of two-dot chain lines in FIG. 10) of a plurality of types of paper P in the width direction X which are different in the width dimension of the paper P. In the present embodiment, the distances Rpc connecting adjacent ribs 23 to each other in the width direction X are different from each other. The distances Rpc may be equal to each other.

The plurality of abandonment portions 25 are formed in the same shape as the nozzle arrays 34 at positions facing the nozzle arrays 34 of the nozzle groups 35 in FIG. 9. In other words, a nozzle group in which the length of the plurality of abandonment portions 25 in the width direction X is formed to be sequentially increased or decreased toward the downstream direction in the transport direction Y is arranged in the width direction X.

As illustrated in FIG. 10, since the lengths of the abandonment portions 25 arranged in the transport direction Y in the width direction X are different from each other, a configuration of the abandonment portions 25 extending between the plurality of ribs 23 which are arranged in the transport direction Y and a configuration of the abandonment portions 25 being formed on the positions which is different from the ribs 23 in the width direction X are mixed at the same position of the support base 20 in the transport direction Y. In other words, the positions of the rib-to-rib positions Dv in the transport direction Y are different from each other in the plurality of ribs 23. According to the configuration, the same effects as those of (1) to (4) of the first embodiment can be obtained.

### Fifth Embodiment

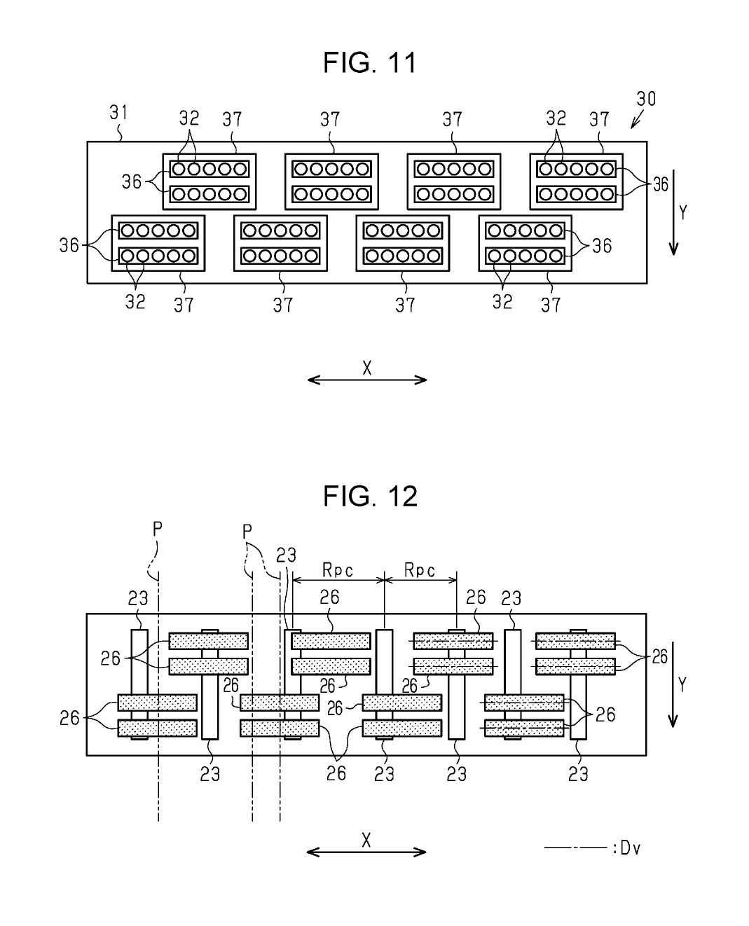

With reference to FIG. 11 and FIG. 12, a printing apparatus 10 of a fifth embodiment will be described. The printing apparatus 10 of the present embodiment is different from the printing apparatus 10 of the first embodiment in the nozzles 32 of the discharge head 31 being arranged differently, the positions of the ribs 23 of the support base 20 in the width direction X being different from each other, and an abandonment portion 26 having a different shape and arrangement from the abandonment portion 24 being formed.

As illustrated in FIG. 11, a plurality of nozzle groups 37 is formed in a zigzag shape (hereinafter, also referred to as “zigzag pattern”) in the transport direction Y and the width direction X, in the discharge head 31, the nozzle arrays 36 are arranged in the transport direction Y in the nozzle group 37, and the nozzles 32 is arrayed in the width direction X in the nozzle array 36. Therefore, portions of the nozzle arrays 36 of the nozzle group 37 adjacent to each other in the transport direction Y overlap each other in the transport direction Y. The lengths of the nozzle arrays 36 of the nozzle group 37 in the width direction X is equal to each other.

As illustrated in FIG. 12, each of the plurality of ribs 23 is arranged in the transport direction Y. The ribs 23 are formed at positions facing the gaps of the plurality of nozzle arrays 36 (see FIG. 11). In other words, the ribs 23 do not face the plurality of nozzle arrays 36. The plurality of ribs 23 arranged in the width direction X are disposed so that the positions thereof become positions which are different from end edges (a plurality of two-dot chain lines in FIG. 12) of a plurality of types of paper P, in the width direction X, of which width dimensions of paper P are different from each other. In the present embodiment, the distances Rpc connecting adjacent ribs 23 to each other in the width direction X which is array direction of the plurality of ribs 23 are different from each other. The distance Rpc may be equal to each other.

The plurality of abandonment portions 26 are formed in the same shape as the nozzle arrays 36 (see FIG. 11) at positions facing the nozzle arrays 36 of the nozzle groups 37. In other words, a group of two abandonment portions 26 having the same length in the width direction X arrayed in the transport direction Y are formed in a zigzag pattern.

As illustrated in FIG. 12, a configuration in which the abandonment portions 26 extend between the plurality of ribs 23 arranged in the transport direction Y and a configuration in which the abandonment portions 26 are formed on the positions which are different from the ribs 23 in the width direction X are mixed in the same position in the transport direction Y of the support base 20. In other words, the positions of the rib-to-rib positions Dv in the transport direction Y are different from each other in the plurality of ribs 23. According to the configuration, the same effects as those of (1) to (4) of the first embodiment can be obtained.

### MODIFICATION EXAMPLE

Each of the above embodiments may be changed to another embodiment as follows.

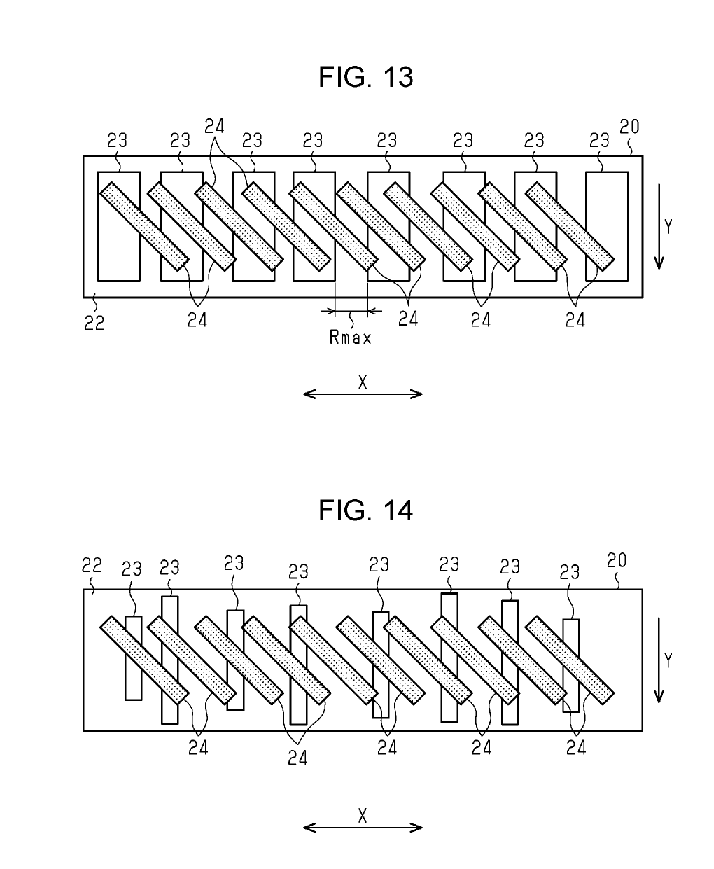

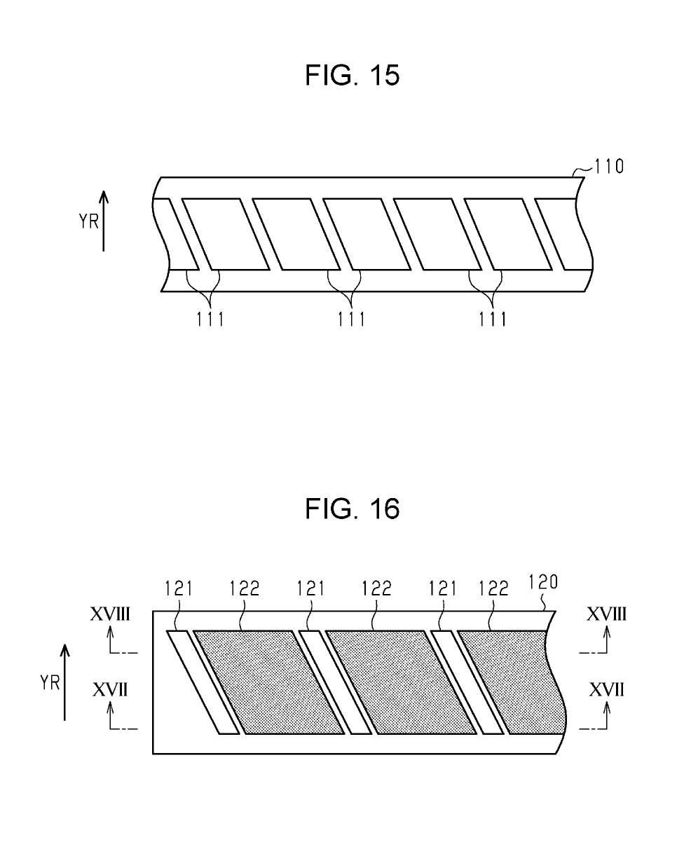

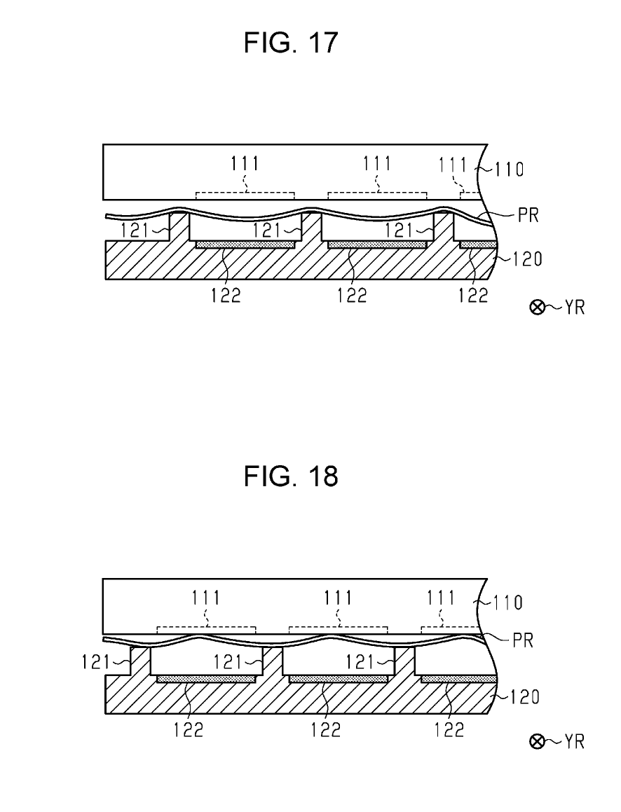

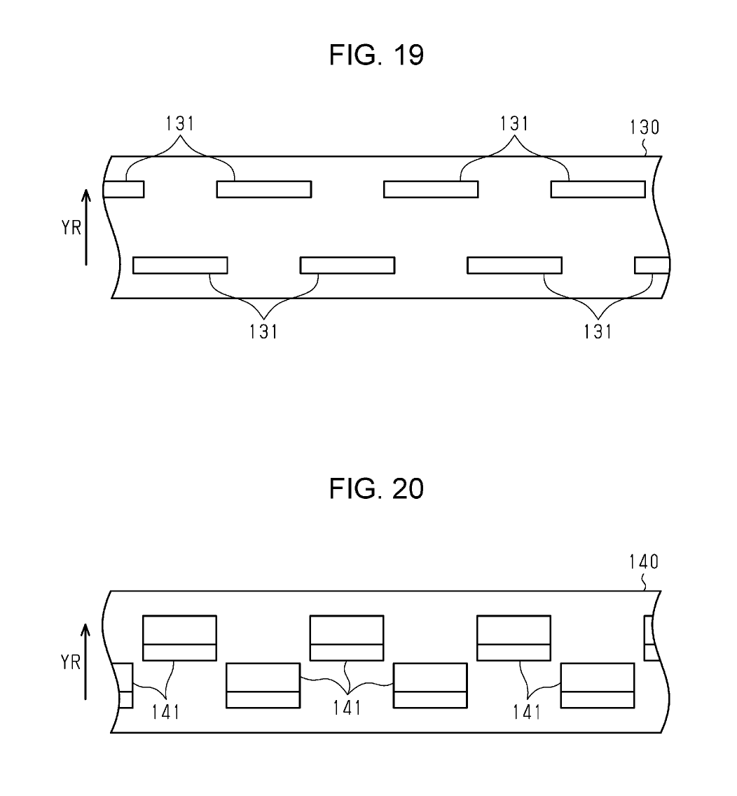

In the first embodiment, as illustrated in FIG. 13, the dimension of the rib 23 in the width direction X (hereinafter, “width dimension of rib 23”) may be equal to or greater than the largest distance Rmax among the distances between the ribs 23 adjacent to each other in the width direction X. In short, the width dimension of the rib 23 can be arbitrarily set as long as the paper P is hung down between the ribs 23 adjacent to each other in the width direction X, in a case where printing is performed on the paper P supported by the rib 23. The second to fifth embodiments can be changed in the same manner.

In the modification example illustrated in FIG. 13, the width dimension of at least two ribs 23 of the plurality of ribs 23 may be different from each other.

In the first embodiment, as illustrated in FIG. 14, at least one of the position of the upstream side end portion of the rib 23 on the most upstream side and the position of the downstream side end portion of the rib 23 on the most downstream side, among the plurality of ribs 23 arranged in the transport direction Y may be different from each other in the ribs 23 arranged in the width direction X. The second embodiment to fifth embodiment and the modification example of FIG. 13 can be changed in the same manner.

In each embodiment and modification examples of FIGS. 13 and 14, an inclined portion which is inclined upwardly toward the downstream side in the transport direction Y may be formed, in the upstream side end portion in the transport direction Y on the downstream side of the rib 23 in the transport direction Y among the ribs 23 which are arranged in the transport direction Y. According to the configuration, in a case where the paper P is transported, the paper P is unlikely to be caught by the ribs 23. The inclined portion may be formed on the upstream side end portion in the transport direction Y of each of the ribs 23 arranged in the transport direction Y.

In each embodiment, the suction mechanism 50 is included, a collection device (not shown) for collecting ink and the support base 20 may be separately formed from each other, and the support base 20 may be attached to the collection device. In this case, the collection device is provided below the support base 20. The abandonment portion 24 of the support base 20 communicates with the internal space of the collection device. The ink discharged from the discharge head 31 during flushing is collected in the internal space of the collection device through the abandonment portion 24 by driving the suction mechanism 50.

In each embodiment, the suction mechanism 50 may be omitted.

In each embodiment, the paper P may be printed with a plurality of colors of ink by a plurality of discharge heads 31 which discharge inks of different colors being arranged side by side in the transport direction Y.

In each embodiment, the printing apparatus 10 is not limited to a configuration having only a printing function, and may be a multifunction peripheral.

The medium is not limited to the paper P, and may be a continuous paper, a film made of resin, a metal foil, a metal film, a composite film (laminate film) of resin and metal, a woven fabric, a nonwoven fabric, a ceramic paper, or the like.

In each embodiment, the liquid discharging apparatus is embodied in an ink jet printer (printing apparatus), but it is not limited to this, and may be a liquid discharging apparatus which discharges other liquid other than ink (liquid, a liquid body of particles of functional material being dispersed or mixed in liquid, a fluid body such as a gel). For example, the liquid discharging apparatus may be a liquid discharging apparatus that discharges liquid materials containing materials such as electrode materials and color materials (pixel materials) in a dispersed or dissolved form used for manufacturing liquid crystal displays, electroluminescence (EL) displays, and surface emitting displays. Further, the liquid discharging apparatus may be a liquid discharging apparatus which discharges bioorganic materials used for biochip production, or a liquid discharging apparatus which discharges liquid as a sample used as a precision pipette. Furthermore, the liquid discharging apparatus may be a liquid discharging apparatus which discharges lubricating oil using a pinpoint to a precision machine such as a watch or a camera, a liquid discharging apparatus which discharges transparent resin liquid such as ultraviolet curable resin in order to form a micro hemispherical lens (optical lens) used for an optical communication element or the like on substrates, or a liquid discharging apparatus which discharges an etching solution such as acid or alkali in order to etch a substrate or the like.

The entire disclosure of Japanese Patent Application No.: 2016-000402, filed Jan. 5, 2016 is expressly incorporated by reference herein.

What is claimed is:

1. A liquid discharging apparatus, comprising:
a support base that supports a medium which is transported; and
a line type discharge head that is disposed at a position facing the support base with a gap between the discharge head and the support base and discharges liquid on the medium which passes over the support base,
wherein the discharge head includes a plurality of nozzle arrays which are arrayed in the direction which is obliquely intersected with a transport direction of the medium, and the support base includes an upstream rib and a downstream rib, and a plurality of receiving portions which are positioned at a location facing each of the plurality of nozzle arrays and which receives the liquid which is discharged from the plurality of nozzle arrays during flushing of the discharge head,
wherein the upstream rib and the downstream rib are positioned in an area between a nozzle in an upstream end and a nozzle in a downstream end in the transport direction, in one nozzle array in the plurality of nozzle arrays,
wherein the upstream rib is positioned at least in the upstream of the nozzle of the downstream end and the downstream rib is positioned at least in the downstream of the nozzle of the upstream end, and
wherein, with respect to a virtual line connecting a center of each nozzle of one nozzle array, the upstream rib is positioned in the upstream of the transport direction than the virtual line and the downstream rib is positioned in the downstream of the transport direction than the virtual line.

2. The liquid discharging apparatus according to claim 1,
wherein each position which is sandwiched between the upstream rib and the downstream rib in adjacent receiving portions to each other are different from each other in the direction intersecting with the transport direction among the plurality of receiving portions.

3. The liquid discharging apparatus according to claim 1,
wherein the support base includes an upstream rib which corresponds to another nozzle array and a downstream rib which corresponds to another nozzle array, which is adjacent to one nozzle array in the transport direction, and
wherein the upstream rib which corresponds to another nozzle array is common to the downstream rib which corresponds to the one nozzle array.

4. The liquid discharging apparatus according to claim 2,
wherein a plurality of upstream ribs and a plurality of downstream ribs are positioned in the direction perpendicular to the transport direction, and
wherein an end edge of each medium in the width direction having a width dimension which is capable of transporting is disposed in order not to be in contact with each of the plurality of upstream ribs and the plurality of downstream ribs, among a plurality of media having width dimension defined by the standard in advance.

5. The liquid discharging apparatus according to claim 4, further comprising:
a suction mechanism that sucks the liquid which is discharged during flushing of the discharge head in an inside portion of the support base through the receiving portion.
